(19) United States
(12) Patent Application Publication
(10) Pub. No.: US 2011/0239834 A1
(43) Pub. Date: Oct. 6, 2011

(54) METHOD AND APPARATUS FOR PROCESSING HOLE WITH ROUNDED EDGE

(76) Inventors: Yoji Kanie, Aichi (JP); Masato Nakashima, Aichi (JP)

(21) Appl. No.: 12/442,670

(22) PCT Filed: Sep. 28, 2007
(86) PCT No.: PCT/JP2007/069513

§ 371 Date: Mar. 24, 2009

(30) Foreign Application Priority Data
Sep. 28, 2006 (JP) 2006-26539

(51) Int. Cl. B26F 1/02; B26F 1/14

(52) U.S. Cl. 83/14; 83/685

(57) ABSTRACT

An apparatus for processing a hole with a rounded edge includes a punch having a rounded shape formed at a base portion of a cutting tip, and a die supporting a peripheral edge of a pierced hole formed through piercing by the cutting tip of the punch with a pressure receiving surface perpendicular to a punch axis. By driving the punch to make a single stroke motion, a hole is pierced in a work piece by the cutting tip of the punch to form the pierced hole and the rounded shape of the cutting tip is transferred onto a ridge portion on the side of a design surface of the pierced hole. This permits efficient processing of holes with a rounded edge. In addition, by supporting the peripheral edge of the pierced hole with the pressure receiving surface, a uniform and highly accurate rounded shape can be formed on the ridge portion of the pierced hole.

### TECHNICAL FIELD

The present invention relates to a method and an apparatus for processing a hole having a ridge portion on which a rounded shape is formed.

### BACKGROUND ART

A vehicle mounted with a periphery monitor device is known (see, for example, Patent Document 1). The periphery monitor device includes a plurality of sonar (sound navigation ranging) devices disposed at a front bumper of the vehicle and detects an obstacle existing forward or sideways of the vehicle based on an output signal from each of the sonar devices. As a result, the vehicle mounted with the periphery monitor device has a plurality of sonar device mounting holes formed in the front bumper. These sonar device mounting holes are formed by performing punching operations of the front bumper after resin molding on a punch press. Each of the sonar device mounting holes immediately after the punching operations offers poor appearance because of a jagged peripheral edge (cut end) on the side of a design surface. Most vehicles mounted with such periphery monitor devices are typically luxury cars and thus required to offer particularly high appearance quality.

Common practice has it therefore that a clearance sonar device having a larger outline than the sonar device mounting hole is fitted into the sonar device mounting hole to thereby conceal the peripheral edge of the sonar device mounting hole. The clearance sonar device, however, protrudes from the design surface of the front bumper and therefore cannot be applied to such vehicles that are required to offer particularly high appearance quality. A technique has also been developed (see, for example, Patent Document 2), in which the peripheral edge of each sonar device mounting hole is rounded by transferring a round shape thereto after the punching operation of the front bumper. This, however, involves a separate setup for the rounding, thus posing a problem in terms of productivity. Further, if the round forming method of Patent Document 2 is adopted, it is extremely difficult to uniformly round the peripheral edge of the sonar device mounting hole, because the peripheral edge of the sonar device mounting hole is not supported by a die. Moreover, relatively large burrs occur on the peripheral edge on the side of the back surface of the sonar device mounting hole, which poses a quality problem. Should the peripheral edge of the sonar device mounting hole be supported by the die, an ordinary die has a chamfered opening portion, so that burrs occur due to a material flowing onto the chamfer.

Patent Document 1: Japanese Patent Application Publication No. JP-A-2005-275850

Patent Document 2: Japanese Patent Application Publication No. JP-A-05-282632

### DISCLOSURE OF THE INVENTION

### [Problem to be Solved by the Invention]

The present invention has been made under the foregoing circumstances and it is an object of the present invention to provide a method and an apparatus for processing a hole with a rounded edge, capable of efficiently obtaining a uniform and highly accurate hole with a rounded edge, while preventing burrs from occurring.

### [Means for Solving the Problem]

To solve the foregoing problem, a method for processing a hole with a rounded edge according to the present invention is a method for processing a hole having a ridge portion on which a rounded shape is formed. The method is characterized by performing, during a single stroke motion of a punch, the steps of forming a pierced hole by piercing a hole in a workpiece with a cutting tip of the punch and rounding with a rounded shape formed at a base portion of the cutting tip of the punch while supporting, with a pressure receiving surface formed in a die, the pressure receiving surface being perpendicular to a punch axis, a peripheral edge of the pierced hole formed in the step of piercing a hole.

According to the method for processing a hole with a rounded edge of the present invention, the steps of piercing a hole and rounding can be performed simultaneously (through a single stroke of the punch). This significantly streamlines processing of holes with a rounded edge. In addition, rounding is performed with the rounded shape formed at the base portion of the cutting tip of the punch, while the peripheral edge of the pieced hole is being supported with the pressure receiving surface of the die, the surface being perpendicular to the punch axis. Therefore, a uniform and highly accurate rounded shape can be formed on a ridge portion of the pierced hole and burrs can be prevented from occurring on the back surface of the workpiece.

To solve the foregoing problem, an apparatus for processing a hole with a rounded edge according to the present invention is an apparatus for processing a hole having a ridge portion on which a rounded shape is formed. The apparatus is characterized by including a punch having a rounded shape formed at a base portion of a cutting tip and a die for supporting, with a pressure receiving surface perpendicular to a punch axis, a peripheral edge of a pierced hole formed through piercing by the cutting tip of the punch.

According to the apparatus for processing a hole with a rounded edge of the present invention, a hole is pierced in the workpiece to form the pierced hole with the cutting tip of the punch and the rounded shape formed at the base portion of the cutting tip is transferred onto the ridge portion of the pierced hole during a single stroke motion of the punch. Therefore, hole piercing and rounding can be performed simultaneously (through a single stroke of the punch). This significantly streamlines processing of holes with a rounded edge. In addition, the rounded shape formed at the base portion of the cutting tip of the punch is transferred onto the peripheral edge of the pierced hole, while supporting the peripheral edge of the pieced hole with the pressure receiving surface of the die, the surface being perpendicular to the punch axis. Consequently, a uniform and highly accurate rounded shape can be formed on the ridge portion of the pierced hole and burrs can be prevented from occurring on the back surface of the workpiece.

### [Aspects of the Invention]

Aspects of an invention which is considered claimable in the present application (hereinafter referred to as the “claimable invention”) will be exemplified and each of the exemplary aspects will be described below. Each of these aspects is herein itemized and numbered in the same manner as in the appended claims and depends from other aspect(s), where appropriate. This is done for easier understanding of the claimable invention. It is not intended to limit combinations of elements constituting the claimable invention to those described in each of these aspects. Specifically, the claimable invention should be interpreted in the light of, for example, the following descriptions accompanying the various aspects and embodiments. Within a limit in accordance with such an interpretation, an aspect of the claimable invention can be constituted by not only any one of these aspects but also either an aspect provided by any one of these aspects and additional element or elements incorporated therein and an aspect provided by any one of these aspects without some of the elements recited therein.

Note that, in the aspects described below, aspects (1) and (3) correspond to claims 1 and 2, respectively.

(1) A method for processing a hole having a ridge portion on which a rounded shape is formed, characterized by comprising the steps of: forming a pierced hole by piercing a hole in a workpiece with a cutting tip of a punch; and rounding with a rounded shape formed at a base portion of the cutting tip of the punch while supporting, with a pressure receiving surface formed in a die, the pressure receiving surface being perpendicular to a punch axis, a peripheral edge of the pierced hole formed in the step of piercing a hole, the steps being performed during a single stroke motion of the punch.

The method for processing a hole with a rounded edge as described in this aspect performs the piercing and rounding steps simultaneously (through a single stroke of the punch). This eliminates the step of rounding a pierced hole produced through piercing with the punch, thus significantly streamlining processing of holes with a rounded edge. Further, the rounded shape (inner rounded shape) formed at the base portion of the cutting tip of the punch is transferred onto the ridge portion of the pierced hole, while the peripheral edge of the pierced hole is supported with the pressure receiving surface of the die, the surface being perpendicular to the punch axis. This allows a uniform and highly accurate rounded shape to be formed on the ridge portion of the pierced hole and prevents burrs from occurring on the back surface of the workpiece.

This aspect is applied, for example, to processing a sonar device mounting hole in a vehicle front bumper after resin molding. In this case, the ridge portion of the sonar device mounting hole can be rounded at the same time as the sonar device mounting hole is pierced, which significantly reduces the number of man-hours required for manufacturing the front bumper. Further, the known art of concealing the peripheral edge (cut end) of the sonar device mounting hole by fitting the clearance sonar device into the sonar device mounting hole detracts from appearance quality, since the clearance sonar device protrudes from the design surface of the front bumper. Application of this aspect allows the sonar device to be mounted flush with (at the same height as) the design surface of the front bumper and the area of the opening of the sonar device mounting hole to be set to the minimum requirement value. This enhances appearance quality of the front bumper and, accordingly, of the entire vehicle.

(2) The method for processing a hole with a rounded edge according to aspect (1) in which the downward stroke end position of the punch is set to a position lowered by a predetermined distance from a position in which a proximal end of the rounded shape of the cutting tip abuts on the ridge portion of the pierced hole.

With the method as described in this aspect, an even more uniform and highly accurate rounded shape can be formed on the ridge portion of the pierced hole.

When processing, for example, a sonar device mounting hole (rounded shape having a radius of 1.2 mm) in a vehicle front bumper after resin molding according to this aspect, it has been determined that accuracy of ±0.2 mm can be ensured of the rounded shape (outer rounded shape) formed on the ridge portion of the pierced hole if the downward stroke end position of the punch is set to a position lowered by 0.2 mm further from a position of the punch reached when the proximal end of the rounded shape of the cutting tip of the punch reaches the height of the design surface of the front bumper. Note herein that the clearance between the punch and the die (two-sided clearance) involved in piercing operation only is typically 0.2 mm. To ensure accuracy in the rounded shape, however, that clearance is set to 0.1 mm.

(3) An apparatus for processing a hole having a ridge portion on which a rounded shape is formed, characterized by including: a punch having a rounded shape formed at a base portion of a cutting tip, and a die for supporting, with a pressure receiving surface perpendicular to a punch axis, a peripheral edge of a pierced hole formed through piercing by the cutting tip of the punch.

According to this aspect, by simply driving the punch to make a single stroke motion, a hole can be pierced in the workpiece by the cutting tip of the punch and a rounded shape (outer rounded shape) is foamed on the ridge portion of the pierced hole by a rounded shape (inner rounded shape) formed at the base portion of the cutting tip. This eliminates the need for manually finishing the ridge portion of the pierced hole, thus achieving a significant reduction in the number of man-hours required for processing holes with a rounded edge. In addition, the rounded shape of the punch is transferred onto the ridge portion of the pierced hole in a condition in which the peripheral edge of the pierced hole is supported with a flat surface (pressure receiving surface) of the die. This ensures a forming pressure for forming a uniform and highly accurate rounded shape on the ridge portion of the pierced hole and prevents burrs from occurring on the back surface of the workpiece.

In this aspect, the shape of the cutting tip of the punch (shape of the pierced hole) is preferably, for example, a circle, an ellipse, or a rectangle. Further preferably, the clearance between the punch and the die is set to a minimum essential value in order to ensure accuracy in the rounded shape formed on the ridge portion of the pierced hole.

(4) The apparatus for processing a hole with a rounded edge according to aspect (3) in which the rounded shape formed at the base portion of the cutting tip and a barrel portion of the punch are continuous with each other via a surface inclined relative to an axially perpendicular surface.

In this aspect, the downward stroke end position of the punch can be set to a position that is lower, within a range of the axial height of the inclined surface formed between the rounded shape and the barrel portion, than the position of the punch reached when the proximal end of the rounded shape of the cutting tip of the punch reaches (abuts on) the surface of the workpiece. Thus, by lowering the punch than the position of the punch reached when the proximal end of the rounded shape of the cutting tip of the punch reaches (abuts on) the surface of the workpiece, an even more uniform and highly accurate rounded shape can be formed on the ridge portion of the pierced hole.

When processing, for example, a sonar device mounting hole (rounded hole) in a vehicle front bumper after resin molding according to this aspect, vehicle appearance quality can be ensured, since the rounded shape formed on the sonar device mounting hole and the design surface of the front bumper are continuous with a stepless, smooth inclined surface therebetween.

### [Effects of the Invention]

A method and an apparatus for processing a hole with a rounded edge can be provided that can produce a uniform and highly accurate hole with a rounded edge efficiently, while preventing burrs from occurring.

### BRIEF DESCRIPTION OF THE DRAWINGS

FIG. 1 shows a condition in which a punch is positioned at an upward stroke end position.

FIG. 2 shows a condition in which the punch is positioned at a downward stroke end position.

FIG. 3 is a partially cross-sectional view showing a condition immediately after a hole is pierced in a front bumper (workpiece) by a cutting tip of the punch during a downward stroke of the punch.

FIG. 4 is an enlarged view showing a principal part of FIG. 2.

### REFERENCE NUMERALS

1: punch

2: cutting tip

3: front bumper (workpiece)

4: pierced hole

5: rounded shape

6: ridge portion

8: die

9: pressure receiving surface

### Best Modes for Carrying Out the Invention

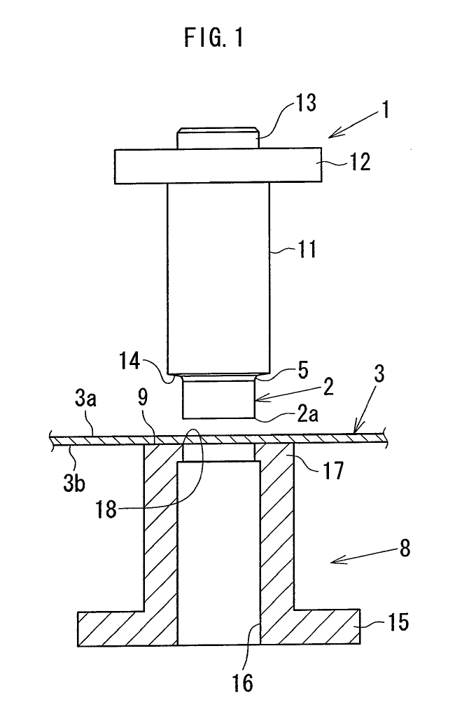

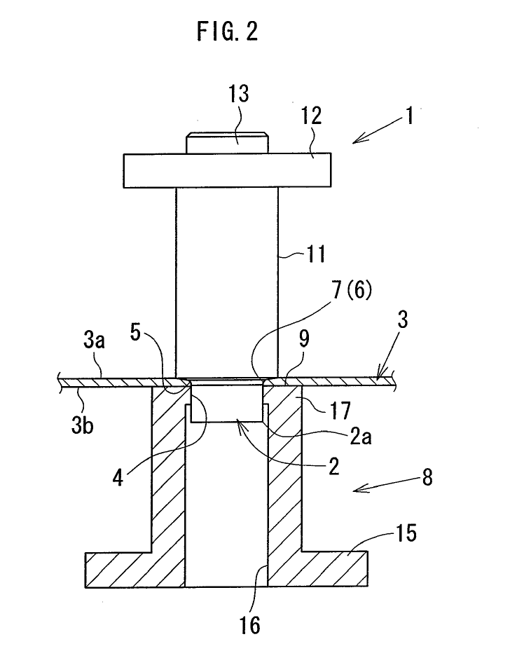

An embodiment of the present invention will be described with reference to FIGS. 1 to 4. An apparatus for processing a hole with a rounded edge according to the embodiment is structured to drive a punch 1 to make a stroke motion (to move the punch 1 from an upward stroke end position shown in FIG. 1 to a downward stroke end position shown in FIG. 2), thereby causing a cutting tip 2 of the punch 1 to pierce a hole in a workpiece 3 so as to form a pierced hole 4 in the workpiece 3 and causing a rounded shape 5 (inner rounded shape) formed at a base portion of the cutting tip 2 of the punch 1 to transfer to a ridge portion 6 on the side of a design surface 3a (appearance surface) of the pierced hole 4, so that a hole with a rounded edge having a rounded shape 7 (outer rounded shape) formed on the ridge portion 6 can be obtained. Further, in the apparatus for processing a hole with a rounded edge, a die 8 has a pressure receiving surface 9 formed by a plane perpendicular to an axis of the punch 1 (hereinafter referred to as the punch axis) and the rounded shape 5 of the punch 1 is transferred to the ridge portion 6 of the pierced hole 4 with the peripheral edge of the pierced hole 4 supported by the pressure receiving surface 9. This results in the apparatus for processing a hole with a rounded edge being structured to enhance processing accuracy of the hole with a rounded edge (the rounded shape 7 formed on the ridge portion 6 of the pierced hole 4) and prevent burrs from occurring on a ridge portion 10 on the side of a back surface 3b of the hole with a rounded edge.

Referring to FIG. 1, the punch 1 includes a barrel portion 11 having a circular axially perpendicular cross-sectional surface. The barrel portion 11 has the cutting tip 2 at a leading end thereof and a flange 12 at a base portion thereof. The punch 1 further includes a positioning pin 13 disposed at a proximal end thereof. The positioning pin 13 is fitted into a ram of a press and the flange 12 is fixed to the ram of the press with a bolt, so that the punch 1 is positioned correctly and fixed in the ram of the press. In addition, the cutting tip 2 of the punch 1 is formed to have an axial cross-sectional shape that corresponds to the pierced hole 4 (a circular shape in this embodiment) and includes an annular cutting edge 2a formed at a leading end corner portion of the cutting tip 2. Note that the cutting tip 2 has a leading end surface formed into an inner conical surface (an elevation angle of 15° in this embodiment). Further, the punch 1 includes the rounded shape 5 (images of the inner rounded shape and the outer rounded shape 7 to be formed on the ridge portion 6 of the pierced hole 4) having a predetermined radius (1.2 mm in this embodiment) around the base portion of the cutting tip 2 and an annular inclined surface 14 inclined at a predetermined angle (10° in this embodiment) relative to an axially perpendicular surface around the rounded shape 5, so that a proximal end 5a of the rounded shape 5 of the cutting tip 2 has a smooth continuation with the inclined surface 14 without any steps.

Referring to FIG. 1, the die 8 is formed into a rectangular parallelepiped having a square axially perpendicular cross section. The die 8 includes a flange 15 disposed at a base portion thereof and a hollow portion 16 extending coaxially with an axis thereof, the hollow portion 16 for allowing scrap to pass therethrough. In addition, the die 8 includes a pressure receiving portion 17 at a leading end thereof. The pressure receiving portion 17 is provided with an annular cutting edge 18 formed at a center thereof. The pressure receiving surface 9 is formed by a plane in parallel with the axially perpendicular surface. Clearance between the punch 1 and the die 8 is set to be smaller than in an ordinary operation of piercing in order to achieve processing accuracy of the rounded shape 7 formed on the ridge portion 6 of the pierced hole 4 (the clearance (two-sided clearance) is set to 0.1 mm in this embodiment as compared with an ordinary 0.2 mm). Note that the die 8 is positioned and fixed to a table of the press as the flange 15 is fixed thereto with a positioning pin and a bolt.

A method for processing a sonar device mounting hole (hole with a rounded edge) on which the rounded shape 7 (outer rounded shape) is formed in a vehicle front bumper 3 (workpiece 3) after resin molding using the apparatus for processing a hole with a rounded edge will be next described. Note that the punch 1 has the following dimensions: the cutting tip 2 has an outside dimension of 17.4 mm; the barrel portion 11 has an outside dimension of 25 mm; and the rounded shape 5 (inner rounded shape) has a radius of 1.2 mm (R1.2). The clearance (two-sided clearance) from the die 8 is set to 0.1 mm.

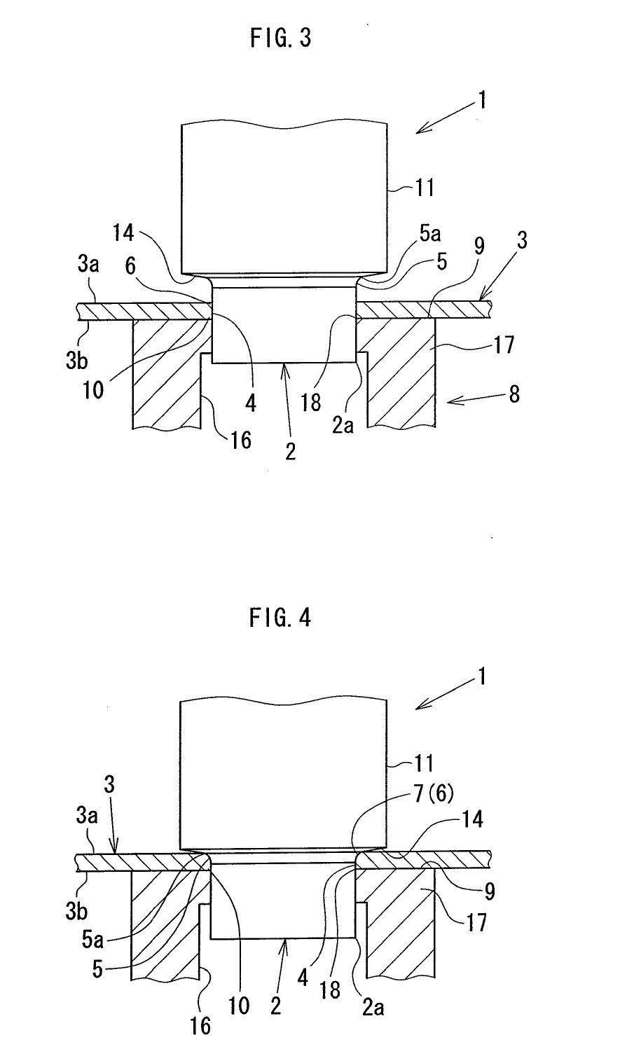

When the punch 1 at the upward stroke end position (see FIG. 1) is lowered, a hole is pierced in the front bumper 3 by the cutting tip 2 of the punch 1 during the downward process as shown in FIG. 3, so that the pierced hole 4 is formed in the front bumper 3. When the punch 1 is further lowered, the rounded shape 5 formed at the base portion of the cutting tip 2 of the punch 1 is transferred onto the ridge portion 6 on the side of the design surface 3a (appearance surface 3a) of the pierced hole 4 with the peripheral edge of the pierced hole 4 in the front bumper 3 supported on the pressure receiving surface 9 of the die 8. Then, referring to FIGS. 2 and 4, when the punch 1 reaches the downward stroke end position, the sonar device mounting hole on which the rounded shape 7 (outer rounded shape) is formed is formed in the front bumper 3. At this time, the downward stroke end position of the punch 1 is set to a position lowered by 0.2 mm from a position of the punch 1 reached when the proximal end 5a of the rounded shape 5 of the cutting tip 2 of the punch 1 reaches the height of the design surface 3a of the pierced hole 4. This results in the inclined surface 14 of the punch 1 abutting on the design surface 3a of the front bumper 3 when the punch 1 reaches the downward stroke end position.

This embodiment achieves the following advantageous effects.

The apparatus for processing a hole with a rounded edge includes the punch 1 having the rounded shape 5 (inner rounded shape) formed at the base portion of the cutting tip 2 and the die 8 for supporting, with the pressure receiving surface 9 that is perpendicular to the punch axis, the peripheral edge of the pierced hole 4 formed through piercing with the cutting tip 2 of the punch 1. The apparatus drives the punch 1 to make a stroke motion, thereby causing the cutting tip 2 of the punch 1 to pierce a hole in the front bumper 3 (workpiece 3) and causing the rounded shape 5 of the cutting tip 2 to transfer to the ridge portion 6 on the side of the design surface 3a of the pierced hole 4, so that a sonar device mounting hole (hole with a rounded edge) having the rounded shape 7 (outer rounded shape) is formed in the front bumper 3.

This allows the apparatus for processing a hole with a rounded edge to eliminate the need for manually finishing the ridge portion 6 of the pierced hole 4 as has been done conventionally, thus achieving a significant reduction in the number of man-hours required for processing the sonar device mounting hole (hole with a rounded edge). In addition, in this apparatus for processing a hole with a rounded edge, the rounded shape 5 of the punch 1 is transferred onto the ridge portion 6 of the pierced hole 4 in a condition in which the peripheral edge of the pierced hole 4 in the front bumper 3 (workpiece 3) is supported by a flat surface (pressure receiving surface 9) of the die 8. This enhances processing accuracy of the rounded shape 7 formed on the ridge portion 6 of the pierced hole 4 and prevents burrs from occurring on the back surface 3b of the front bumper 3.

Additionally, in the apparatus for processing a hole with a rounded edge, the proximal end 5a of the rounded shape 5 (inner rounded shape) formed at the base portion of the cutting tip 2 of the punch 1 continues smoothly, without any steps, onto the inclined surface 14 that forms a predetermined angle (10° in this embodiment) relative to the axially perpendicular surface. Further, the clearance between the punch 1 and the die 8 is set to be smaller than in the ordinary operation of piercing only (0.1 mm in this embodiment as compared with an ordinary 0.2 mm).

In the apparatus for processing a hole with a rounded edge, therefore, the downward stroke end position of the punch 1 is set to a position lowered by a predetermined distance (0.2 mm in this embodiment) within a range of the axial height of the inclined surface 14 from the position of the punch 1 reached when the proximal end 5a of the rounded shape 5 of the cutting tip 2 reaches the height of the design surface 3a of the pierced hole 4. This ensures that a forming pressure is uniformly applied to the ridge portion 6 of the pierced hole 4, so that a uniform and highly accurate rounded shape 7 (outer rounded shape) can be formed on the ridge portion 6 of the pierced hole 4. The rounded shape 7 (outer rounded shape) and the design surface 3a can also be made smoothly continuous without any steps and the sonar device can be mounted flush with the design surface 3a of the front bumper 3. This enhances appearance quality of the front bumper 3 and, accordingly, of the entire vehicle.

Note that the embodiment is not limited only to the foregoing and the following arrangement, for example, may be possible.

The embodiment has been described for an exemplary case in which the sonar device mounting hole (rounded hole) is produced in the front bumper (workpiece) after resin molding. The workpiece is not limited to the resin molding, but may be a metal part. In this case, the downward stroke end position of the punch is set appropriately according to the material of the workpiece.

Further, the shape of the hole with a rounded edge is not necessarily a circle; but may, for example, be an ellipse or a rectangle.

1. A method for processing a hole having a ridge portion on which a rounded shape is formed, comprising the steps of:
forming a pierced hole by piercing a hole in a work_piece with a cutting tip of a punch;
rounding with a rounded shape formed at a base portion of the cutting tip of the punch while supporting, with a pressure receiving surface formed in a die, the pressure receiving surface being perpendicular to a punch axis, a peripheral edge of the pierced hole formed in the step of piercing a hole; and
abutting an annular inclined surface extended to the rounded shape of the punch against a design surface of the pierced hole,
the steps being performed during a single stroke motion of the punch.

2. An apparatus for processing a hole having a ridge portion on which a rounded shape is formed, comprising:
a punch formed with a rounded shape and an inclined surface in which to be provided at the periphery of the rounded shape and extended to the rounded shape, the rounded shape and the inclined surface being provided at a base portion of a cutting tip of the punch; and
a die for supporting with a pressure receiving surface perpendicular to a punch axis a peripheral edge of a pierced hole formed through piercing by the cutting tip of the punch.

3. The method for processing a hole having a ridge portion on which a rounded shape is formed, according to claim 1, wherein the work piece is a resin-made part.

4. The apparatus for processing a hole having a ridge portion on which a rounded shape is formed, according to claim 2, wherein the inclined surface extended to the rounded shape is inclined at 10° relative to an axially perpendicular surface of the punch.
